(19) United States
(12) Patent Application Publication
(10) Pub. No.: US 2026/0269627 A1
(43) Pub. Date: Sep. 10, 2026

(54) POWER GENERATING SYSTEM

(71) Applicant: YAMABIKO CORPORATION, Tokyo (JP)

(72) Inventors: Taishi SUMIKAWA, Tokyo (JP); Mitsuru INOUE, Tokyo (JP); Takuya ARAKAWA, Tokyo (JP)

(21) Appl. No.: 19/445,959

(22) Filed: Jan. 12, 2026

(30) Foreign Application Priority Data
Mar. 4, 2025 (JP) 2025-033965

(51) Int. Cl. H02J 3/38; H02H 7/122; H02J 3/32; H02J 101/10; H02J 101/20

(52) U.S. Cl. CPC H02J 3/381; H02H 7/122; H02J 3/32; H02J 2101/10; H02J 2101/20

(57) ABSTRACT

A power generating system includes a generator, a battery, and a power conditioner. The generator includes an output voltage switching device that switches an output voltage between a first set voltage and a second set voltage. A power line switching device that selectively switches between a first power supply line through which electric power output from the generator is supplied to the load via the power conditioner and a second power supply line through which electric power output from the generator is supplied to the load without passing through the power conditioner is provided on an output side of the generator. The power line switching device selects the first power supply line when the output voltage is switched to a first set voltage by the output voltage switching device, and selects the second power supply line when the output voltage is switched to a second set voltage.

### CROSS-REFERENCE TO RELATED APPLICATIONS

The present application claims priority from Japanese Patent Application No. 2025-033965 filed on March 4, 2025, and the entire contents of which are hereby incorporated by reference.

### BACKGROUND

### Technical field

The present invention relates to a power generating system.

### Related Art

During autonomous operation in which a generator supplies AC power to a load without connection to the power grid, the power generated by the generator and the power consumed by the load must be kept in constant balance to maintain stable power generation. In such a system, the generator output is controlled based on the detected power consumption of the load. However, when the load varies sharply, the control response cannot follow quickly enough, and the balance cannot be properly maintained.

To address this, a system has been employed in which the generator output is controlled, the resulting DC power is supplied to a power conditioner and stored in a battery, and the power conditioner converts the DC power from the battery into AC power to be supplied to the load. Such a system can supply stable power to the load by controlling the charging and discharging of the battery through the control of the power conditioner in response to load fluctuations, as disclosed in, for example, Japanese Patent Application Laid-Open No. 2019-58023. The entire contents of this disclosure are hereby incorporated by reference.

### SUMMARY

An aspect of the present invention has the following features. A power generating system includes: a generator configured to output AC power; a battery configured to store DC power converted from output of the generator; and a power conditioner configured to convert output of the battery into AC power and supply the AC power to a load. The generator includes an output voltage switching device configured to switch an output voltage between a first set voltage and a second set voltage. A power line switching device configured to selectively switch between a first power supply line and a second power supply line is provided on an output side of the generator, wherein the first power supply line is a line through which electric power output from the generator is supplied to the load via the power conditioner, and the second power supply line is a line through which electric power output from the generator is supplied to the load without passing through the power conditioner. The power line switching device selects the first power supply line when the output voltage is switched to a first set voltage by the output voltage switching device, and selects the second power supply line when the output voltage is switched to a second set voltage by the output voltage switching device.

### BRIEF DESCRIPTION OF THE DRAWINGS

FIG. 1 is a diagram illustrating an example configuration of a power generating system according to an embodiment of the invention;

FIG. 2 is a diagram illustrating an example of an output voltage switching device of a generator;

FIG. 3 is a diagram illustrating an example of wiring selection performed by a power line switching device when a first set voltage V1 is selected;

FIG. 4 is a diagram illustrating an example of wiring selection performed by the power line switching device when a second set voltage V2 is selected; and

FIG. 5 is a flowchart illustrating an example of operation of the power generating system.

### DETAILED DESCRIPTION

The conventional system described above is configured such that the electric power generated by the generator is constantly supplied to the load via the power conditioner, and therefore, when the power conditioner stops operating, the power supply to the load is interrupted. The power conditioner rarely stops operation due to failure. However, the power conditioner requires periodic inspection for component replacement and other maintenance that inevitably forces the system to shut down. Therefore, ensuring a continuous power supply to the load even while the power conditioner is shut down for maintenance has become an important issue in such systems.

To address this, it is conceivable to supply electric power directly from the generator to the load by bypassing the power conditioner when the power conditioner is stopped. In such a configuration, however, since the generator is sometimes operated at a relatively high set voltage (for example, approximately 400 V) in consideration of charging efficiency of the battery during normal operation, it becomes necessary to switch or adjust the generator output voltage to a level suitable for directly supplying power to the load (for example, approximately 200 V). To safely perform such switching or adjustment of the generator output voltage, it is necessary to take cumbersome measures such as arranging for a licensed electrician. Accordingly, when supplying power directly from the generator to the load during maintenance of the power conditioner, it has been difficult to ensure smooth and safe operation.

The present invention is proposed to address the above-described issues. That is, the present invention provides a power generating system configured to supply electric power generated by a generator to a load via a battery and a power conditioner, and to enable the electric power output from the generator to be reliably and safely supplied directly to the load when the power conditioner is stopped.

Hereinafter, an embodiment of the present invention will be described with reference to the drawings. The same reference numbers in the different drawings indicate the same functional parts, and therefore repeated description for each of the drawings is omitted.

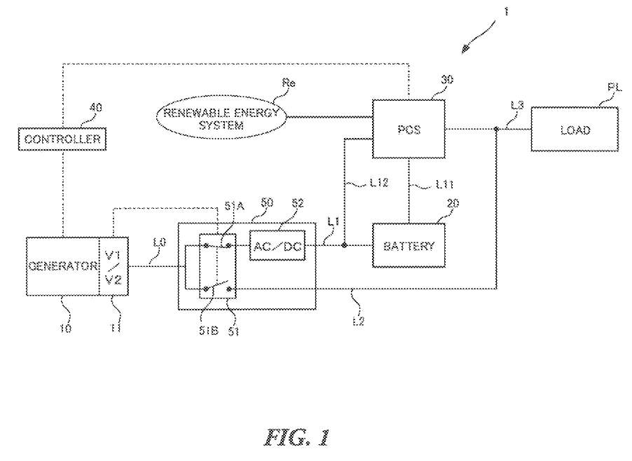

As shown in FIG. 1, a power generating system 1 according to an embodiment of the invention includes a generator 10, a battery 20, and a power conditioner 30, and is configured to supply electric power output from the generator 10 to a load PL. As the generator 10 configured to output AC power, a three-phase or single-phase AC generator such as a synchronous generator or an induction generator, which uses a prime mover driven by a fossil-fuel engine such as a diesel engine or a gasoline engine, can be employed.

The battery 20 is configured to store DC power converted from the output of the generator 10 and is a rechargeable secondary battery. As an example of the battery 20, a lithium-ion battery, a lead-acid battery, a nickel-cadmium battery, or a nickel-metal hydride battery can be used. The battery 20 serves as a buffer for the power output from the generator 10. By supplying the power once stored in the battery 20 to the load PL via the power conditioner 30, it is possible to achieve stable power supply to the load PL.

The power conditioner 30 is configured to convert the DC power converted from the generator output and DC power output from the battery 20 into AC power, and to supply the AC power to the load PL. Generally, the power conditioner 30 is connected to a renewable energy power generating system Re that utilizes renewable energy sources such as solar, wind, geothermal, and biomass, and converts electric power from these sources into AC power to supply to the load PL. In addition, the power conditioner 30 has a function of storing part or all of the electric power in the battery 20 when excessive power is supplied from the renewable energy power generating system Re. Hereinafter, the power conditioner 30 will be referred to as a PCS (power conditioner system) 30.

The generator 10 used in the power generating system 1 is provided with an output voltage switching device 11 that can switch the output voltage between a first set voltage V1 and a second set voltage V2. The first set voltage V1 is a voltage set to enable efficient charging of the battery 20, and, as one example, is a relatively high voltage of around 400 V. Meanwhile, the second set voltage V2 is a voltage suitable for directly supplying power to the load PL, and, as one example, is a relatively low voltage of around 200 V.

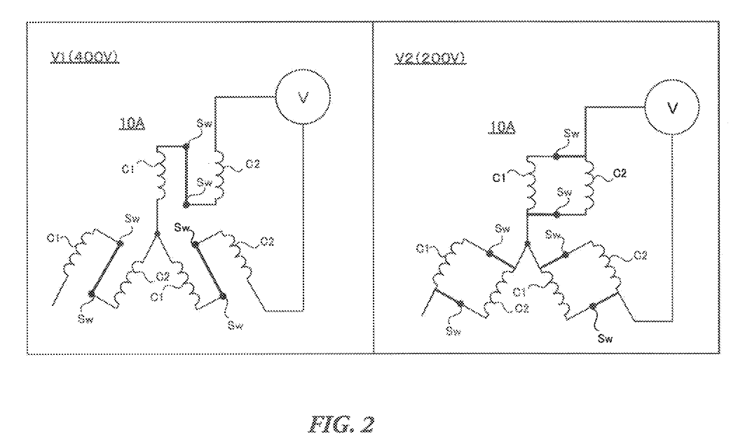

The output voltage switching device 11 provided in the generator 10 mechanically switches the output voltage by means of various switching mechanisms. FIG. 2 illustrates an example of the output voltage switching device 11. In the illustrated example, the output voltage switching device 11 performs switching between the first set voltage V1 and the second set voltage V2 by using a switching mechanism Sw such as a cam switch to connect two winding coils C1 and C2 of each phase of a generator body 10A in series at the first set voltage V1 and in parallel at the second set voltage V2. The output voltage switching device 11 is not limited to this example, and may alternatively be configured to switch between a phase-to-phase voltage and a line-to-line voltage of the generator body 10A by means of a switching mechanism.

The power generating system 1 may include a control unit (hereinafter referred to as “controller”) 40 configured to control the generator 10 and the PCS 30. The controller 40 can control the generator 10 to adjust the output voltage and to start the operation, and can also control the PCS 30 to adjust the AC power supplied to the load PL. In particular, in performing charging control of the generator 10 described later, the controller 40 controls the startup operation of the generator 10 to charge the battery 20 based on charge/discharge management information of the battery 20 obtained by the PCS 30.

The power generating system 1 includes a power line switching device 50 on the output side of the generator 10. The power line switching device 50 can selectively switch between a first power supply line L1 and a second power supply line L2. The first power supply line L1 is a line through which electric power output from the generator 10 is supplied to the load PL via the PCS 30. The second power supply line L2 is a line through which electric power output from the generator 10 is supplied to the load PL without passing through the PCS 30. As a result, in the power generating system 1 configured to supply electric power output from the generator 10 to the load PL via the battery 20 and the PCS 30, even when the PCS 30 is stopped, it is possible to directly supply the electric power to the load PL.

The power line switching device 50 includes a wiring switching mechanism (contactor) 51 configured to perform switching operation in conjunction with the switching of the output voltage switching device 11, and an AC/DC conversion circuit 52 configured to supply DC power to the first power supply line L1.

The wiring switching mechanism 51 includes a first circuit breaker 51A and a second circuit breaker 51B. The conduction states of the first circuit breaker 51A and the second circuit breaker 51B are switched to opposite states in conjunction with the switching operation of the output voltage switching device 11.

That is, when the output voltage is switched to the first set voltage V1 by the output voltage switching device 11, the first circuit breaker 51A is turned on, and the second circuit breaker 51B is turned off. As a result, an output line L0 of the generator 10 is connected to the first power supply line L1, and AC power at the first set voltage V1 is converted into DC power via the AC/DC converter 52 and then supplied, through the first power supply line L1, to the battery 20 or the PCS 30. The power output from the PCS 30 is then supplied to the load PL through a connection line L3.

Meanwhile, when the output voltage is switched to the second set voltage V2 by the output voltage switching device 11, the first circuit breaker 51A is turned off, and the second circuit breaker 51B is turned on. As a result, the output line L0 of the generator 10 is connected to the second power supply line L2. AC power at the second set voltage V2 is then supplied to the load PL through the second power supply line L2 and the connection line L3. Here, FIG. 1 illustrates an example in which the first power supply line L1 includes a line L11 to supply DC power to the PCS 30 via the battery 20 and a line L12 to supply DC power directly to the PCS 30. However, the line L12 may be omitted.

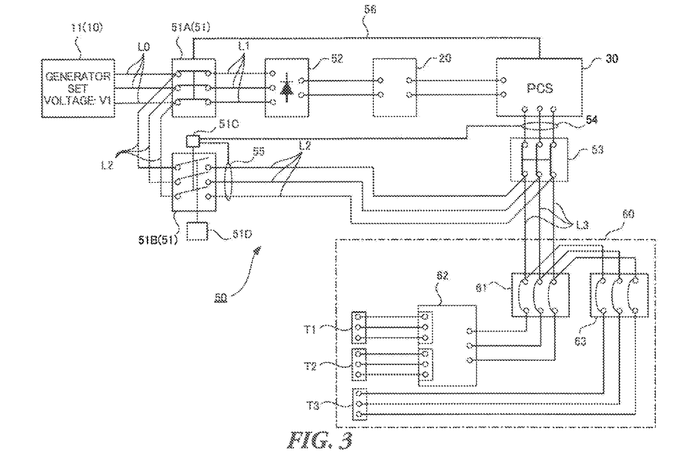

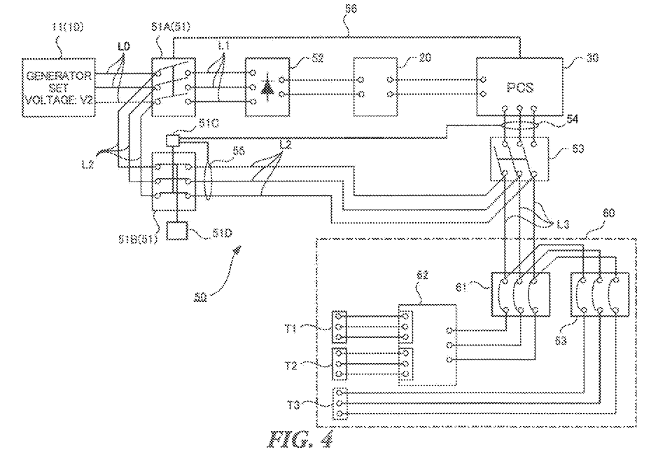

FIG. 3 and FIG. 4 illustrate examples of wiring selection performed by the power line switching device 50. FIG. 3 illustrates a state in which the output voltage is switched to the first set voltage V1, and FIG. 4 illustrates a state in which the output voltage is switched to the second set voltage V2. In the illustrated example, three-phase AC power at either the first set voltage V1 or the second set voltage V2 is outputted to the output line L0 from the generator 10 via the output voltage switching device 11.

In the examples shown in FIG. 3 and FIG. 4, the power line switching device 50 includes a third circuit breaker 53 downstream of the PCS 30. The third circuit breaker 53 has a function of connecting or disconnecting the first power supply line L1 and the connection line L3 leading to the load PL. The third circuit breaker 53 is switched to the same state as the first circuit breaker 51A in conjunction with the operation of the first circuit breaker 51A. By providing the third circuit breaker 53 downstream of the PCS 30, it is possible to prevent unnecessary power from flowing back toward the PCS 30 from the downstream side. By keeping the third circuit breaker 53 in an open state whenever power is supplied to the second power supply line L2, it is possible to avoid interference between the AC power supplied through the second power supply line L2 and the AC power output from the PCS 30.

In the example shown in FIG. 3 and FIG. 4, the first circuit breaker 51A is connected to the output line 10 of the generator 10. The second power supply line L2 is connected to the output line L0 on the primary side of the first circuit breaker 51A, and is also connected to the connection line L3 on the secondary side of the third circuit breaker 53. In addition, a connection terminal section 60 is connected to the connection line L3. The connection terminal section 60 receives three-phase AC power supplied through the connection line L3. The received power is distributed to single-phase output terminals T1 and T2 via an overcurrent breaker 61 and a scott transformer 62, and to a three-phase output terminal T3 via an overcurrent breaker 63.

As shown in FIG. 3, when the output voltage of the generator 10 is switched to the first set voltage V1 by the output voltage switching device 11, three-phase AC power at the first set voltage V1 is outputted from the output line L0. The AC power supplied to the first power supply line L1 via the first circuit breaker 51A in a closed state is converted into DC power by the AC/DC conversion circuit (for example, a full-wave rectifier circuit) 52, and this DC power is used to charge the battery 20. In this state, the PCS 30 is operating to convert the DC power output from the battery 20 into three-phase AC power and supply it to the connection line L3 via the third circuit breaker 53 in a closed state.

In the switching state of the output voltage switching device 11 shown in FIG. 3, the second circuit breaker 51B is in an open state. The power line switching device 50 includes a shutoff-holding mechanism (shutoff-holding relay) 51C configured to maintain the open state of the second circuit breaker 51B. The shutoff-holding mechanism 51C detects the presence or absence of voltage by means of a voltage detector 54 provided on the output side of the PCS 30 and a voltage detector 55 provided on the secondary side of the second circuit breaker 51B. The shutoff-holding mechanism 51C has a shutoff-holding function to maintain the open state of the second circuit breaker 51B when voltage is detected by either of the detectors.

As shown in FIG. 3, when the PCS 30 is operating, voltage is detected by the voltage detectors 54 and 55. Accordingly, the open state of the second circuit breaker 51B is maintained, and the second circuit breaker 51B remains open at least until the operation of the PCS 30 is stopped. By providing this shutoff-holding mechanism 51C, even if a malfunction occurs in the switching operation of the power line switching device 50, it is possible to avoid a situation in which the AC power output from the PCS 30 and the AC power output from the generator 10 conflict with each other.

As shown in FIG. 4, when the output voltage of the generator 10 is switched to the second set voltage V2 by the output voltage switching device 11, three-phase AC power at the second set voltage V2 is outputted from the output line L0. The three-phase AC power output is supplied to the second power supply line L2 via the second circuit breaker 51B in a closed state, and then supplied to the connection line L3, which is connected to the secondary side of the third circuit breaker 53. In this case, the first circuit breaker 51A is in an open state in conjunction with the switching of the output voltage switching device 11.

In the switching state of the output voltage switching device 11 shown in FIG. 4, the second circuit breaker 51B is in a closed state. The power line switching device 50 includes a conduction-holding mechanism (conduction-holding relay) 51D configured to maintain the closed state of the second circuit breaker 51B. The conduction-holding mechanism 51D has a conduction-holding function to maintain the closed state of the second circuit breaker 51B when the second circuit breaker 51B is switched to the closed state, provided that no voltage is detected on the secondary side of the second circuit breaker 51B.

In the state shown in FIG. 4, the PCS 30 is stopped, so that the voltage detectors 54 and 55 do not detect any voltage, and the second circuit breaker 51B remains in the closed state. By this means, even when the PCS 30 is stopped for maintenance, three-phase AC power is supplied to the connection line L3 through the second power supply line L2.

In the state shown in FIG. 4, even if the PCS 30 is operated and power from another power generating system inputted to the PCS 30 is converted into AC power and outputted, because the third circuit breaker 53 is in an open state, it is possible to avoid a situation in which the three-phase AC power output from the generator 10 conflicts with the output of the PCS 30.

The power line switching device 50 has an emergency shutdown function to stop the PCS 30 when the second circuit breaker 51B is switched to a closed state. As one example, this function is implemented by an emergency shutdown signal that is transmitted to the PCS 30 through a signal line 56 from the contact of the first circuit breaker 51A, which operates in conjunction with the operation of the second circuit breaker 51B. The emergency shutdown signal is transmitted after it is confirmed that the second circuit breaker 51B is in a closed state as a result of the disconnection of the first circuit breaker 51A. This emergency shutdown function makes it possible to avoid the situation, described hypothetically in the previous paragraph, where the PCS 30 operates in the state shown in FIG. 4.

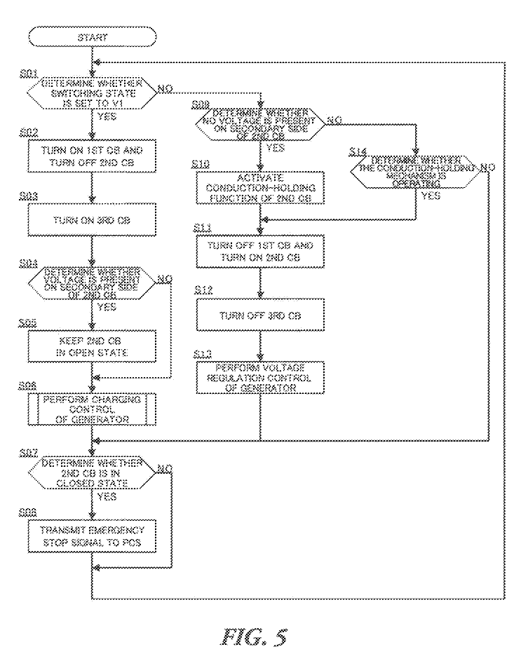

An example of the operation of the power generating system 1 will be described with reference to FIG. 5. When the operation starts, the switching state of the output voltage switching device 11 is determined (step S01). When it is determined that the switching state of the output voltage switching device 11 is set to the first set voltage V1 (Step S01: YES), the wiring switching mechanism 51 turns on the first circuit breaker 51A and simultaneously turns off the second circuit breaker 51B (Step S02). Then, the wiring switching mechanism 51 further turns on the third circuit breaker 53 (Step S03). As a result, the power line switching device 50 selects the first power supply line L1 as shown in FIG. 3 to supply the output of the generator 10 to the load PL via the PCS 30.

At this stage, it is determined whether voltage is present on the secondary side of the second circuit breaker 51B based on the output of the voltage detector 55 (Step S04). When it is determined that voltage is present (Step S04: YES), it can be confirmed that the PCS 30 is in operation, and the shutoff-holding mechanism 51C is activated to keep the second circuit breaker 51B in the open state (Step S05). On the other hand, when it is determined in Step S04 that no voltage is present (Step S04: NO), the operation of the PCS 30 cannot be confirmed. Therefore, the open state of the second circuit breaker 51B is not maintained, and the process proceeds to the next step. In the next step, while the first power supply line L1 is selected, the controller 40 performs charging control of the generator 10 (Step S06).

In the charging control of the generator 10 (Step S06), the controller 40 performs startup operation of the generator 10 to charge the battery 20, based on the charge/discharge management information of the battery 20 acquired by the PCS 30, on the assumption that the first power supply line L1 is selected. In a typical charge control operation, when the state of charge (SOC) falls below a lower limit (for example, 10 %), the generator 10 is started (and remains stopped otherwise), and when the SOC exceeds an upper limit (for example, 35 %), the generator 10 is stopped (and remains running otherwise). When the generator 10 is in operation, its output voltage is adjusted according to the SOC.

In the charging control of the generator 10 (Step S06), the controller 40 can perform charging control according to a predetermined schedule, in addition to the normal charging control described above. In this case, when the preset time arrives, the controller 40 charges the battery 20 up to a relatively high SOC level in advance, thereby avoiding operation of the generator 10 during nighttime, for example. In this case, as an example, the lower limit is set to about 75 % and the upper limit is set to about 85 %, and the same start-up control of the generator 10 in the charging control as described above is performed.

On the other hand, when the determination in Step S01 indicates that the switching state is set to the second set voltage V2 (Step S01: NO), a check is made to determine whether no voltage is present on the secondary side of the second circuit breaker 51B (Step S09), based on the output of the voltage detector 55. When it is determined in Step S09 that no voltage is present (Step S09: YES), it can be confirmed that the PCS 30 is stopped. Then, the conduction-holding mechanism 51D activates the conduction-holding function of the second circuit breaker 51B (Step S10), and the first circuit breaker 51A is turned off while the second circuit breaker 51B is turned on (Step S11).

Then, the third circuit breaker 53 is turned off (Step S12). This allows the power line switching device 50 to select the second power supply line L2 as shown in FIG. 4 to directly supply the output of the generator 10 to the load PL by bypassing the PCS 30. In this state, where the second power supply line L2 is selected, the controller 40 performs voltage regulation control of the generator 10 and output control of the generator 10 according to the load condition of the load PL (Step S13).

Then, when it is determined in Step S09 that voltage is present on the secondary side of the second circuit breaker 51B (Step S09: NO), the controller 40 determines whether the conduction-holding mechanism 51D is operating (Step S14). When the conduction-holding mechanism 51D is operating (Step S14: YES), the controller 40 determines that the second power supply line L2 has already been selected, and proceeds to Step S11 and subsequent steps described above. On the other hand, when it is determined in Step S14 that the conduction-holding mechanism 51D is not operating (Step S14: NO), there is a possibility that the PCS 30 is operating. Therefore, the power line selection in Steps S11 and S12 is not performed, and the process proceeds to Step S07.

In step S07, it is determined whether the second circuit breaker 51B is in a closed state. In the situation where the first power supply line L1 has been selected through Steps S02 to S06, the second circuit breaker 51B is normally in an open state. Therefore, Step S07 results in a NO determination, and the process continues in that state.

In the situation where the second power supply line L2 has been selected through Steps S09 to S13, the second circuit breaker 51B is normally closed. Therefore, Step S07 results in a YES determination, and an emergency stop signal is transmitted to the PCS 30 (Step S08) to forcibly stop the operation of the PCS 30.

When a NO determination is made in Step S14, neither the first power supply line L1 nor the second power supply line L2 is selected. In this state, if the second circuit breaker 51B is turned on (Step S07: YES), the output of the generator 10 and the output of the PCS 30 may conflict with each other. Therefore, the emergency stop signal is transmitted to the PCS 30 (Step S08) to forcibly stop the operation of the PCS 30.

The features of the power generating system 1 described above can be summarized as follows. First, in the power generating system 1 configured to supply power from the generator 10 to the load PL via the battery 20 and the PCS 30, when the PCS 30 is stopped for maintenance including periodic inspection, the switching of the power line switching device 50 enables the output voltage of the generator 10 to be directly supplied to the load PL. As a result, complicated procedures such as arranging a licensed electrician become unnecessary, and it is possible to switch the power supply reliably and safely.

In this case, the switching operation of the power line switching device 50 is performed in conjunction with the switching operation of the output voltage switching device 11 of the generator 10. This allows the power line to be switched simply by switching the output voltage. When power is supplied to the load PL via the battery 20 and the PCS 30, the output voltage of the generator 10 is switched to the first set voltage V1, so that power can be supplied from the PCS 30 to the load PL through the first power supply line L1, while efficiently charging the battery 20. When the PCS 30 is stopped for maintenance or other reasons, the output voltage of the generator 10 is switched to the second set voltage V2 to set an appropriate voltage level, so that power can be supplied directly from the generator 10 to the load PL through the second power supply line L2.

Second, the power line switching device 50 includes the AC/DC conversion circuit 52 configured to supply DC power to the first power supply line L1. By switching the output voltage of the generator 10 to the first set voltage V1 by means of the output voltage switching device 11, DC power at the first set voltage V1 can be supplied to the battery 20 through the first power supply line L1 for charging. Accordingly, the battery 20 can always be charged with high efficiency.

Third, the power line switching device 50 includes the first circuit breaker 51A configured to connect or disconnect the first power supply line L1, and the second circuit breaker 51B configured to connect or disconnect the second power supply line L2. The conduction states of the first circuit breaker 51A and the second circuit breaker 51B are switched to opposite states in conjunction with the switching operation of the output voltage switching device 11. As a result, when either the first power supply line L1 or the second power supply line L2 is conducting, the other is always disconnected. This configuration prevents interference between the power supplies of the first power supply lines L1 and the second power supply line L2, ensuring that the power line switching can be performed safely.

Fourth, the power line switching device 50 includes the third circuit breaker 53 provided downstream of the PCS 30 and configured to connect or disconnect the first power supply line L1 and the connection line L3 leading to the load PL. The third circuit breaker 53 is switched to the same state as the first circuit breaker 51A in conjunction with the operation of the first circuit breaker 51A. When the first circuit breaker 51A is turned on, the third circuit breaker 53 is also turned on. As a result, the first power supply line L1 is connected to the connection line L3, allowing the power output from the PCS 30 to be supplied to the load PL. Meanwhile, when the first circuit breaker 51A is turned off, the third circuit breaker 53 is also turned off. As a result, it is possible to prevent the power supplied through the second power supply line L2 (that is, the power directly supplied from the generator 10) from affecting the output side of the PCS 30. This allows the PCS 30 to be protected.

Fifth, the second power supply line L2 is connected to the output line L0 on the primary side of the first circuit breaker 51A, and is also connected to the connection line L3 on the secondary side of the third circuit breaker 53. By this means, when the second circuit breaker 51B is turned on and the second power supply line L2 is selected, the power is supplied from the output line L0 to the connection line L3 through the second power supply line L2. Meanwhile, when the second circuit breaker 51B is turned off, the third circuit breaker 53 is turned on, so that the output state of the PCS 30 can be detected based on the voltage on the secondary side of the second circuit breaker 51B.

Sixth, the power line switching device 50 has the shutoff-holding function to maintain the open state of the second circuit breaker 51B when voltage is detected on the output side of the PCS 30 or the secondary side of the second circuit breaker 51B. By this means, when the PCS 30 is outputting power, the second circuit breaker 51B is kept open at all times. This ensures that the power output from the PCS 30 does not conflict with the power directly supplied from the generator 10 through the second power supply line L2.

Seventh, the power line switching device 50 has the conduction-holding function to maintain the closed state of the second circuit breaker 51B when the second circuit breaker 51B is switched to the closed state, provided that no voltage is detected on the secondary side of the second circuit breaker 51B. When no voltage is detected on the secondary side of the second circuit breaker 51B and the second circuit breaker 51B is switched to a closed state, this indicates that the PCS 30 has been stopped and the second power supply line L2 has been selected. In this case, by maintaining the closed state of the second circuit breaker 51B, it is possible to ensure the continuity of the power supply directly from the generator 10 to the load PL.

Eighth, the power line switching device 50 has the emergency shutdown function to stop the PCS 30 when the second circuit breaker 51B is switched to a closed state. By this means, when the second circuit breaker 51B is turned on, the second power supply line L2 is selected, and power from the generator 10 is directly supplied to the load PL. In this case, by performing an emergency shutdown of the PCS 30, it is possible to reliably prevent a malfunction in which the power from the generator 10 conflicts with the power from the PCS 30.

Nineth, the power generating system 10 includes the controller 40 configured to control the generator 10 and the PCS 30. The controller 40 performs the start-up operation of the generator 10 to charge the battery 20 based on charge/discharge management information of the battery 20 obtained by the PCS 30 when the first power supply line L1 is selected. By this means, when the first power supply line L1 is selected, the controller 40 starts charging control of the generator 10, thereby keeping the state of charge of the battery 20 at an appropriate level.

Tenth, The PCS 30 converts electric power obtained from renewable energy sources into AC power supplied to the load PL. By this means, the power generating system 1 according to the embodiment of the invention can be incorporated into a system that supplies electric power generated from renewable energy sources to a load, thereby constructing a multi-hybrid power generating system. This makes it possible to ensure a stable power supply by compensating for the instability of power supply from renewable energy sources with the electric power output from the generator 10. Consequently, stable power supply can be achieved while giving priority to the perspective of carbon neutrality.

According to the present invention, the power generating system is configured to supply electric power generated by a generator to a load via a battery and a power conditioner, and to enable the electric power output from the generator to be reliably and safely supplied directly to the load when the power conditioner is stopped.

As described above, the embodiments of the present invention have been described in detail with reference to the drawings. However, the specific configuration is not limited to the embodiments, and the design can be changed without departing from the scope of the present invention. In addition, the above-described embodiments can be combined by utilizing each other’s technology as long as there is no particular contradiction or problem in the purpose and configuration.

1. A power generating system comprising:
a generator configured to output AC power;
a battery configured to store DC power converted from output of the generator; and
a power conditioner configured to convert output of the battery into AC power and supply the AC power to a load, wherein:
the generator includes an output voltage switching device configured to switch an output voltage between a first set voltage and a second set voltage;
a power line switching device configured to selectively switch between a first power supply line and a second power supply line is provided on an output side of the generator, wherein the first power supply line is a line through which electric power output from the generator is supplied to the load via the power conditioner, and the second power supply line is a line through which electric power output from the generator is supplied to the load without passing through the power conditioner; and
the power line switching device selects the first power supply line when the output voltage is switched to a first set voltage by the output voltage switching device, and selects the second power supply line when the output voltage is switched to a second set voltage by the output voltage switching device.

2. The power generating system according to claim 1, wherein the power line switching device includes an AC/DC conversion circuit configured to supply DC power to the first power supply line.

3. The power generating system according to claim 1, wherein the power line switching device includes:
a first circuit breaker configured to connect or disconnect the first power supply line; and
a second circuit breaker configured to connect or disconnect the second power supply line, and
conduction states of the first circuit breaker and the second circuit breaker are switched to opposite states in conjunction with switching operation of the output voltage switching device.

4. The power generating system according to claim 3, wherein:
the power line switching device includes a third circuit breaker provided downstream of the power conditioner and configured to connect or disconnect the first power supply line and a connection line leading to the load; and
the third circuit breaker is switched to same state as the first circuit breaker in conjunction with operation of the first circuit breaker.

5. The power generating system according to claim 4, wherein the second power supply line is connected to an output line of the generator on a primary side of the first circuit breaker, and is also connected to the connection line on a secondary side of the third circuit breaker.

6. The power generating system according to claim 3, wherein the power line switching device has a shutoff-holding function to maintain an open state of the second circuit breaker when voltage is detected on an output side of the power conditioner or a secondary side of the second circuit breaker.

7. The power generating system according to claim 6, wherein the power line switching device has a conduction-holding function to maintain a closed state of the second circuit breaker when the second circuit breaker is switched to the closed state, provided that no voltage is detected on the secondary side of the second circuit breaker.

8. The power generating system according to claim 3, wherein the power line switching device has an emergency shutdown function to stop the power conditioner when the second circuit breaker is switched to a closed state.

9. The power generating system according to claim 1, further comprising a controller configured to control the generator and the power conditioner,
wherein the controller performs start-up operation of the generator to charge the battery based on charge/discharge management information of the battery obtained by the power conditioner when the first power supply line is selected.

10. The power generating system according to claim 1, wherein the power conditioner converts electric power obtained from renewable energy sources into AC power supplied to the load.
